(19) United States
(12) Patent Application Publication
(10) Pub. No.: US 2016/0302291 A1
(43) Pub. Date: Oct. 13, 2016

(54) ELECTRIC SHOCK DEVICE

(71) Applicant: Paul JOSEFIV, Parma, OH (US)

(72) Inventor: Paul JOSEFIV, Parma, OH (US)

(21) Appl. No.: 15/184,028

(22) Filed: Jun. 16, 2016

Related U.S. Application Data
(63) Continuation-in-part of application No. 29/507,382, filed on Oct. 27, 2014, now Pat. No. D761930.

(51) Int. Cl. H05C 1/00

(52) U.S. Cl. CPC H05C 1/00

(57) ABSTRACT

Disclosed is an electric shock device including an elongated body having opposite proximal and distal ends and defining a shaft having longitudinal axis extending between said proximal and distal ends. The distal end of the elongated body carries a hood that is disposed about the elongated body. A cavity defined by the hood extends outwardly away from the proximal end of the device. The distal end of the device terminates in one or more electrically conductive contacts. The proximal end of the elongated carries a handle and an activating member for operating the device. A power unit is operably associated with the elongated body and is selectively activated by the activation member to emit an electrical shock.

This application is a continuation-in-part of U.S. application Ser. No. 29/507,382, filed on Oct. 27, 2014, which is incorporated herein by reference.

### TECHNICAL FIELD

The present disclosure relates to an personal protection device including a hood to provide a protective barrier between the operator and an attacker, such as a humans, snakes and other animals, and a component capable of delivering an electrical shock to the attacker.

### BACKGROUND

The need for an effective and practical personal protection device, particularly useful against animal attacks, such as snakes, is widely recognized. The primary method of avoiding an attack today is escape. This method, however, is not very desirable because there are too many variables which affect its utility. There have also been many instances in which the potential victim becomes seriously injured in the attempt to escape. In addition, conventional shock devices do not provide an adequate means to quickly ward off an attacker from a relatively safe distance. Rather, the user must physically contact the attacker with the shock device in order to prevent or impede an ensuing attack. Such a situation creates a high risk of injury to the user, as the attacker is generally not deterred by the appearance of the shock device and will continue the attack until contacted with the shocking mechanism. In addition, contacting the attacker with the shock device often requires skill and/or dexterity by the user. For example, dogs are generally approaching at a high rate of speed and can easily avoid contact with the shock mechanism and snakes can easily lunge at a user and inflict a potentially lethal injury before being contacted by the shock mechanism. There is, therefore, a need in the art to provide a device that can quickly and easily deploy a protective barrier between the user and a would-be attacker that wards off an attacker from a relatively safe distance.

### BRIEF DESCRIPTION

Disclosed is an electric shock device comprising an elongated body comprising a longitudinal axis and opposite proximal and distal ends, a handle at said proximal end of said elongated body, a hood carried by said elongated body, wherein said hood defines a cavity facing toward said distal end of said elongated body, an electrically conductive contact at said distal end of said elongated body, an electric power source in electrical communication with said electrically conductive contact, and an activation member in communication with said electric power source.

### BRIEF DESCRIPTION OF THE DRAWINGS

FIG. 1 is a perspective view of a first illustrative embodiment of the electrical shock device.

FIG. 2 is a side view of the electrical shock device shown in FIG. 1.

FIG. 3 is an end view of the electrical shock device shown in FIG. 1.

FIG. 4 is an end view of the electrical shock device shown in FIG. 1.

FIG. 5 is a perspective view of a second illustrative embodiment of the electrical shock device.

FIG. 6 is a side view of the electrical shock device shown in FIG. 5.

FIG. 7 is an end view of the electrical shock device shown in FIG. 5.

FIG. 8 is an end view of the electrical shock device shown in FIG. 5.

FIG. 9 is a perspective view of a third illustrative embodiment of the electrical shock device.

FIG. 10 is a side view of the electrical shock device shown in FIG. 9.

FIG. 11 is an end view of the electrical shock device shown in FIG. 9.

FIG. 12 is an end view of the electrical shock device shown in FIG. 9.

FIG. 13 is a perspective view of a fourth illustrative embodiment of the electrical shock device.

FIG. 14 is an end view of a fifth illustrative embodiment of the electrical shock device.

FIG. 15 is a perspective view of a sixth illustrative embodiment of the electrical shock device.

### DETAILED DESCRIPTION

Disclosed is an electric shock device which is useful to protect against animal attacks. Also disclosed is an electric shock device that can be carried easily and used as a cane or walking stick when not being used as a defensive device.

The electric shock device comprises an elongated body having opposite proximal and distal ends. The elongated body comprises a longitudinal axis and opposite proximal and distal ends. A handle for gripping the device is located at the proximal end of the elongated body. A foot pad to assist in walking may be located at the proximal end of the elongated body. The foot pad is typically comprised of an elastomeric material or shock absorbing material or the like so as to make contact with the ground surface.

A protective barrier such as a hood is carried by the elongated body. The hood defines a cavity facing toward the distal end of the elongated body. The distal end of the elongated body terminates with an electrically conductive contact. The shock device includes an electric power source that is in electrical communication with the electrically conductive contact. The shock device includes an activation member that is in communication with the electric power source.

According to certain embodiments, the electric shock device may include a second handle that is positioned along the elongated body. The second handle is positioned along the elongated body between the first handle and the hood member. According to certain embodiments, the second handle may be positioned substantially equidistant from the first handle and the hood member.

The hood member includes a rear side that faces the proximal end of the elongated body of the shock device and a front side that faces the distal end of the elongated body. In certain embodiments, the hood is selectively movable between opened and closed positions. The hood may be opened and closed by sliding a collar member along the elongated body in known fashion. A coil spring may be operatively engaged with the collar member to assist in the opening of the hood.

When the hood is in the open position, the substantially concave surface is disposed outwardly toward the distal end of the device. The hood may have a wide variety shapes. By way of illustration, and not limitation, the shape of the opened hood may have a cross-sectional shape selected from the group consisting of a circle, oval, oblong, triangle, square, pentagon, hexagon, heptagon or octagon.

The actuation of the hood into its open position provides a protective barrier or shield against an attacker and can be used to intimidate or warn a potential attacker. It has been shown that some animals are frightened by the opening of such a hood to the point of aborting their attack. The hood thus discourages attackers by intimidation, and does not injure the would-be attacker.

The one or more electrically conductive contacts are positioned at or near the distal end of the electric shock device. According to certain illustrative embodiments, the distal end of the elongated body terminates with one or more electrically conductive contact(s). The one or more conductive contacts may be positioned at least partially within the hood. For illustrative embodiments when the distal end terminates with one or more electrically conductive contacts, then these contacts are positioned at a position that is distal from the end of the opened hood.

The electrically conductive contacts are configured to deliver or otherwise provide a high-voltage electric shock to a would-be attacker. The electrically conductive contacts are in electrical communication with a power source. Typically, the electrically conductive contacted are electrically connected or otherwise coupled to the power source by electrically conductive wiring. According to certain embodiments, the electrically conductive contacts are electrically connected to the power source by elongated electrically conductive wiring. The electrically conductive wiring may be housed within the elongated body and may extend coaxially along at least a portion of the length of the elongated body to connect the power source to the conductive contacts.

In certain illustrative embodiments, the one or more conductive contacts are conductively coupled to the high-voltage power source. Typically, an electrical wiring extends between the power high-voltage unit and the conductive contacts. According to certain embodiments, the power unit may comprises a battery. According to other embodiments, the power unit may comprise a battery and a voltage amplifying circuit. The battery may comprise a rechargeable battery such as, without limitation, a lithium or nickel metal hydride battery. In certain embodiments, the power unit comprises a power inlet socket, a resistor, a capacitor, a bridge rectifier, and a battery. This illustrative power unit enables the recharging of the battery from an alternating current source, which is changed to a direct current to recharge the battery.

An activation member activates the power unit. In one embodiment, the activation member comprises a power switch and a voltage discharge switch. Power is supplied to the capacitor by actuating the power switch. High voltage from the capacitor is supplied to the one or more conductive contacts by actuating the voltage discharge switch.

The elongated body may be selectively expandable and retractable in length. For example, the elongated body may comprise a second tubular member having an outer diameter less than the inner diameter of a first tubular member, so as to be slidably moved and repositioned with respect thereto. This configuration defines a telescoping elongated body.

The electric shock device may further comprise a holding member that is attached or otherwise positioned along longitudinal axis of the elongated body. The holding member may comprise a ring member and/or a clamping member that is attached to the outer circumference of the ring member. The clamp member is configured to couple an illumination device to the elongated body for illuminating an area adjacent to, or generally aligned with, the hood of the device and/or the area of the ground in the immediate area of the distal end of the elongated body. The ring member of the holding member may be coaxially engaged about the outer circumference of the elongated body at a position between the proximal end and the hood member. The upstanding clamping member of the holding member may have an open top portion and is configured to accept and holding an illumination device of any exterior geometry. For example, and without limitation, the holding member comprises a ring member to be friction fitted coaxially about the outer circumference of the elongated body and a substantially semi-circular clamping member attached to the outer circumference of the ring member. According to this embodiment, the ring member can be friction fitted coaxially onto the elongated body and the clamping member can hold an illumination device having an outer geometry in the shape of a circle. The illumination device may be used to assist the user in viewing the area near the distal end of the elongated body of the electric shock device, as well as illuminating a would-be attacker. Not only does such illumination assist the user in correctly aiming and stabbing towards the attacker, but could potentially also deter any such attack.

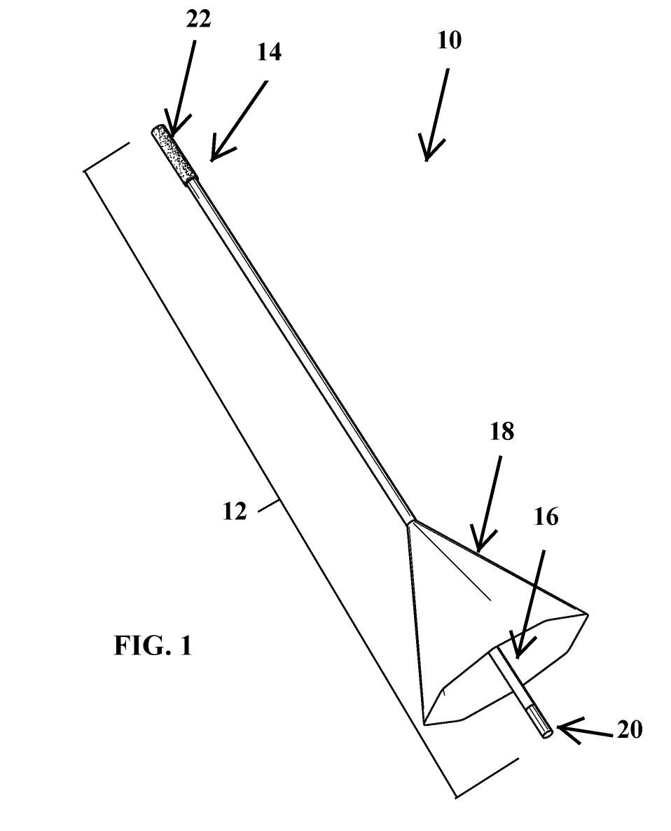

The electric shock device is readily understood when read in conjunction with illustrative FIGS. 1-15. It should be noted that the electric shock device is not limited to any of the illustrative embodiments shown in the drawing figures, but rather should be construed in breadth and scope in accordance with the disclosure provided herein.

FIG. 1 is a perspective view of a first illustrative embodiment of the electrical shock device 10. Electric shock device 10 is generally comprised of an elongated body 12. Elongated body 12 comprises opposite proximal 14 and distal 16 end portions. The elongated body extends along longitudinal axis extending between proximal 14 and distal 16 ends. According to the illustrative embodiment shown in FIG. 1, the elongated body is configured in the shape of an elongated pole, rod, or shaft having a round outer geometry when viewed in cross-section. The hood member 18 is attached to the elongated body 12 at a position near the distal end 16 of the elongated body 12. The one or more electrically conductive contacts 20 capable of delivering a high-voltage shock to an attacker is attached to the distal end 16 of the body 12. The electrically conductive contacts 20 are positioned at a point along the longitudinal length of the elongated body 12 at a point that is distal to the hood member 18. Therefore, the electrically conductive contacts 20 extend from the body 12 from a point that is outwardly from hood 18. The hood 18 has a generally octagonal configuration, although this shape should be considered to be non-limiting. Proximal end 14 of elongated body 12 comprises handle 22 and an activation member (not shown) for activating the power source for delivering an electrical shock via the electrical conductive contacts 20 to a would-be attacker. It will be appreciated by those skilled in the art that the handle can take on a variety of shapes and configurations. High-voltage power unit (not shown) is operably associated with elongated body 12 and is selectively actuated by activation member.

FIG. 2 is a side view of the electrical shock device shown in FIG. 1. Electric shock device 10 is generally comprised of an elongated body 12. Elongated body 12 comprises opposite proximal 14 and distal 16 end portions. The elongated body extends along longitudinal axis extending between proximal 14 and distal 16 ends. The elongated body 12 is configured in the shape of an elongated pole, rod, or shaft having a round outer geometry when viewed in cross-section. The hood member 18 is attached to the elongated body 12 at a position near the distal end 16 of the elongated body 12. The one or more electrically conductive contacts 20 capable of delivering a high-voltage shock to an attacker is attached to the distal end 16 of the body 12. The electrically conductive contacts 20 are positioned at a point along the longitudinal length of the elongated body 12 at a point that is distal to the hood member 18. Therefore, the electrically conductive contacts 20 extend from the body 12 from a point that is outwardly from hood 18. The hood 18 has a generally octagonal configuration, although this shape should be considered to be non-limiting. Proximal end 14 of elongated body 12 comprises handle 22 and an activation member (not shown) for activating the power source for delivering an electrical shock via the electrical conductive contacts 20 to a would-be attacker. High-voltage power unit (not shown) is operably associated with elongated body 12 and is selectively actuated by activation member.

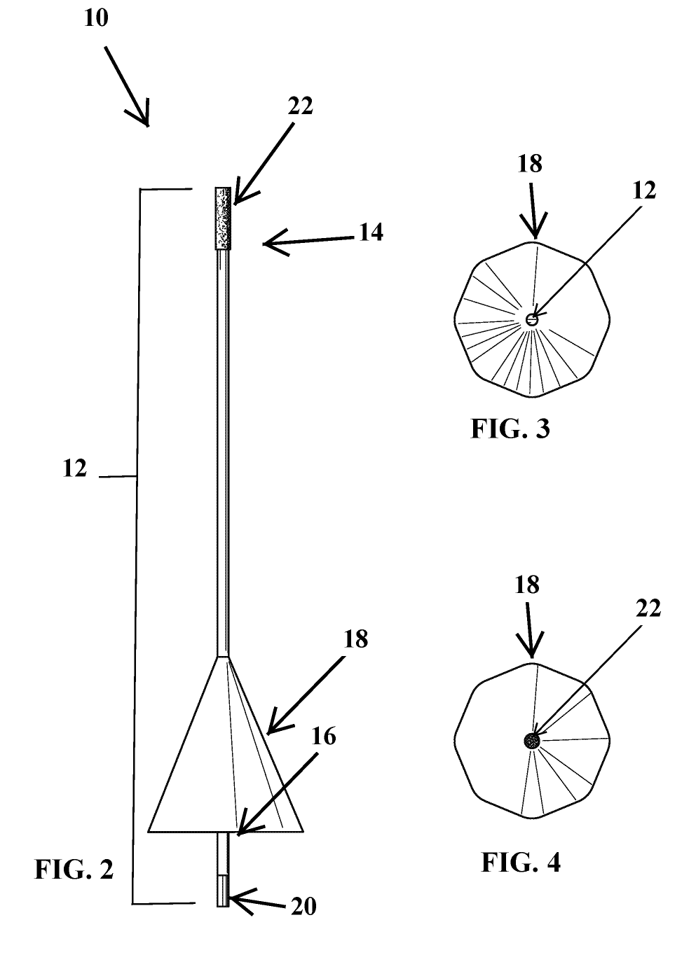

FIG. 3 is a proximal end view of the electrical shock device shown in FIG. 1. The electrically conductive contacts (not shown) are positioned at a point along the longitudinal length of the elongated body 12 at a point that is distal to the hood member 18. Therefore, the electrically conductive contacts extend from the body 12 from a point that is outwardly from hood 18. The hood 18 has a generally octagonal configuration, although this shape should be considered to be non-limiting.

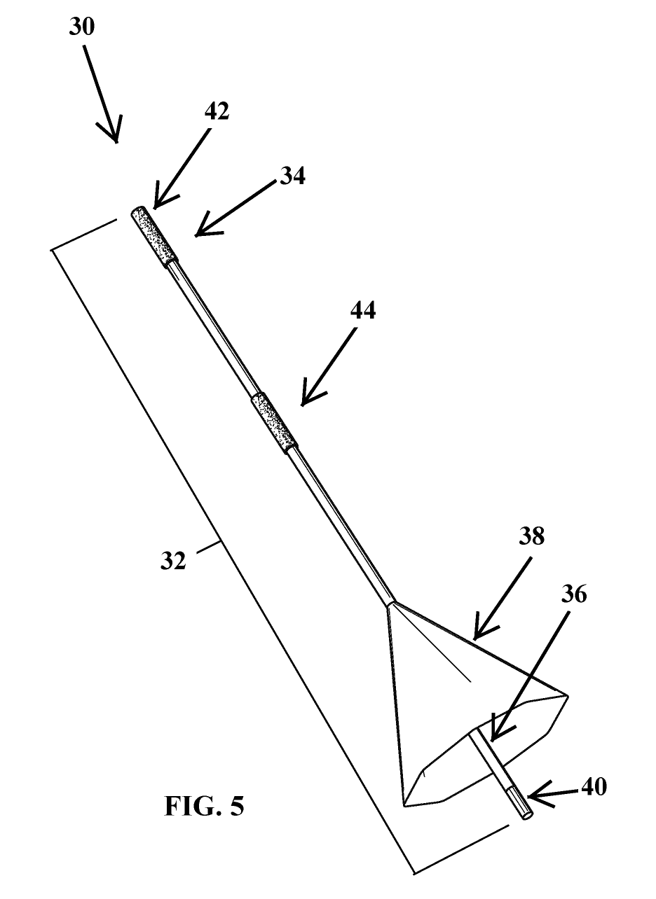

FIG. 4 is a distal end view of the electrical shock device shown in FIG. 1. The electrically conductive contacts 20 are positioned at a point along the longitudinal length of the elongated body at a point that is distal to the hood member 18. Therefore, the electrically conductive contacts 20 extend from the body from a point that is outwardly from hood 18. The hood 18 has a generally octagonal configuration, although this shape should be considered to be non-limiting.

FIG. 5 is a perspective view of a second illustrative embodiment of the electrical shock device 30. Electric shock device 30 is generally comprised of an elongated body 32. Elongated body 32 comprises opposite proximal 34 and distal 36 end portions. The elongated body extends along longitudinal axis extending between proximal 34 and distal 36 ends. According to the illustrative embodiment shown in FIG. 5, the elongated body 32 is configured in the shape of an elongated pole, rod, or shaft having a round outer geometry when viewed in cross-section. The hood member 38 is attached to the elongated body 32 at a position near the distal end 36 of the elongated body 32. The one or more electrically conductive contacts 40 capable of delivering a high-voltage shock to an attacker is attached to the distal end 36 of the body 32. The electrically conductive contacts 40 are positioned at a point along the longitudinal length of the elongated body 32 at a point that is distal to the hood member 38. Therefore, the electrically conductive contacts 40 extend from the body 32 from a point that is outwardly from hood 38. The hood 38 has a generally octagonal configuration, although this shape should be considered to be non-limiting. Proximal end 34 of elongated body 32 comprises handle 42 and an activation member (not shown) for activating the power source for delivering an electrical shock via the electrical conductive contacts 40 to a would-be attacker. Second handle 44 is positioned along a longitudinal axis of said elongated body 32 between said handle 42 and said hood 38. It will be appreciated by those skilled in the art that the handles 42 and 44 can take on a variety of shapes and configurations. High-voltage power unit (not shown) is operably associated with elongated body 32 and is selectively actuated by activation member.

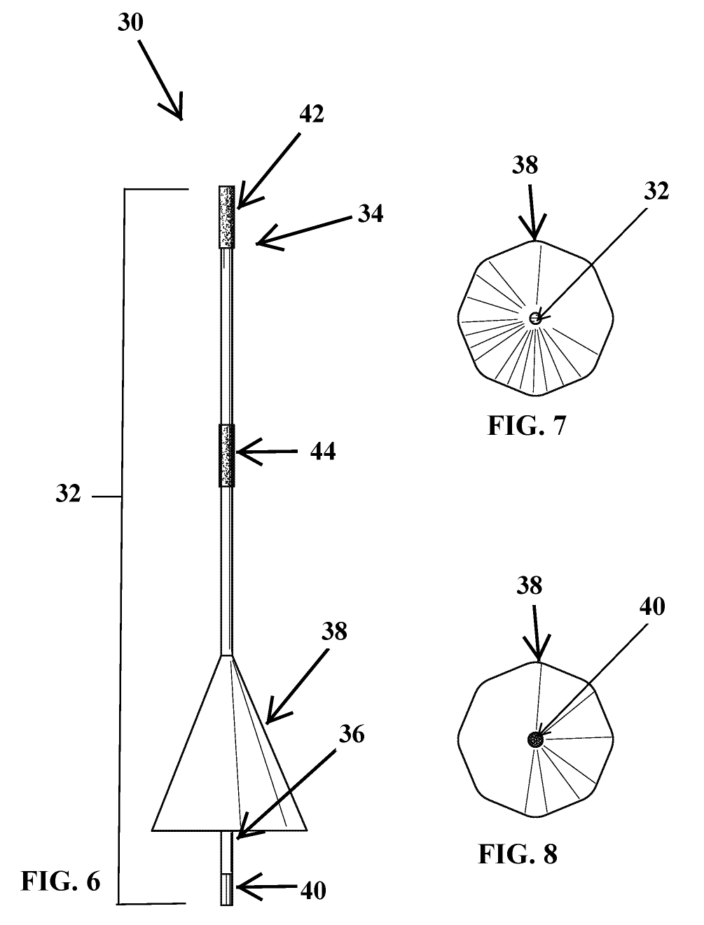

FIG. 6 is a side view of the electrical shock device shown in FIG. 5. Electric shock device 30 is generally comprised of an elongated body 32. Elongated body 32 comprises opposite proximal 34 and distal 36 end portions. The elongated body extends along longitudinal axis extending between proximal 34 and distal 36 ends. The elongated body 32 is configured in the shape of an elongated pole, rod, or shaft having a round outer geometry when viewed in cross-section. The hood member 38 is attached to the elongated body 32 at a position near the distal end 36 of the elongated body 32. The one or more electrically conductive contacts 40 capable of delivering a high-voltage shock to an attacker is attached to the distal end 36 of the body 32. The electrically conductive contacts 40 are positioned at a point along the longitudinal length of the elongated body 32 at a point that is distal to the hood member 38. Therefore, the electrically conductive contacts 40 extend from the body 32 from a point that is outwardly from hood 38. The hood 38 has a generally octagonal configuration, although this shape should be considered to be non-limiting. Proximal end 34 of elongated body 32 comprises handle 42 and an activation member (not shown) for activating the power source for delivering an electrical shock via the electrical conductive contacts 40 to a would-be attacker. Second handle 44 is positioned along a longitudinal axis of said elongated body 32 between said handle 42 and said hood 38. It will be appreciated by those skilled in the art that the handles 42 and 44 can take on a variety of shapes and configurations. High-voltage power unit (not shown) is operably associated with elongated body 32 and is selectively actuated by activation member.

FIG. 7 is a proximal end view of the electrical shock device shown in FIG. 5. The electrically conductive contacts (not shown) are positioned at a point along the longitudinal length of the elongated body 32 at a point that is distal to the hood member 38. Therefore, the electrically conductive contacts extend from the body 32 from a point that is outwardly from hood 38. The hood 38 has a generally octagonal configuration, although this shape should be considered to be non-limiting.

FIG. 8 is a distal end view of the electrical shock device shown in FIG. 5. The electrically conductive contacts 40 are positioned at a point along the longitudinal length of the elongated body at a point that is distal to the hood member 38. Therefore, the electrically conductive contacts 40 extend from the body from a point that is outwardly from hood 38. The hood 38 has a generally octagonal configuration, although this shape should be considered to be non-limiting.

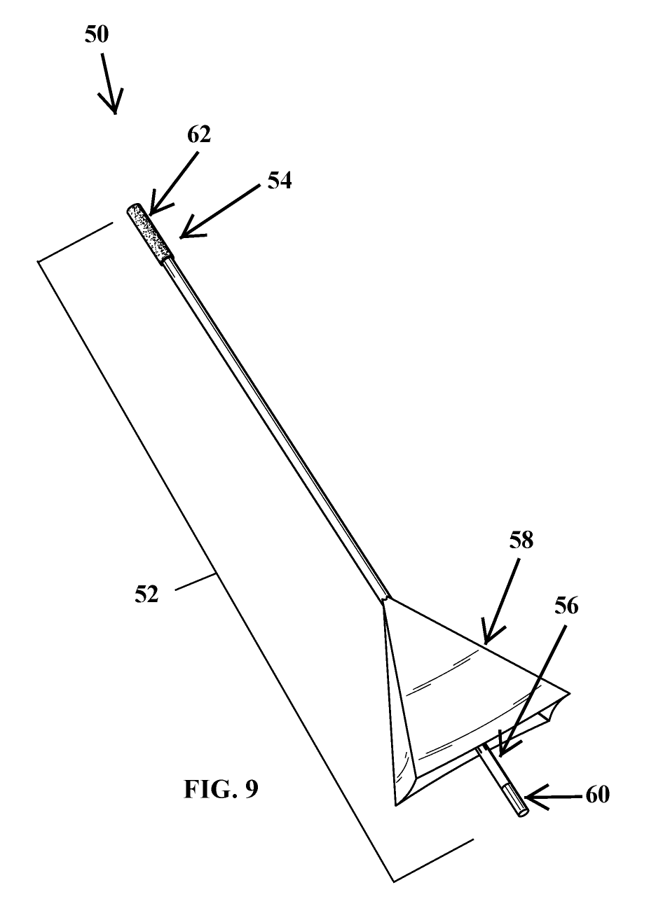

FIG. 9 is a perspective view of a third embodiment of the electrical shock device 50. Electric shock device 50 is generally comprised of an elongated body 52. Elongated body 52 comprises opposite proximal 54 and distal 56 end portions. The elongated body extends along longitudinal axis extending between proximal 54 and distal 56 ends. According to the illustrative embodiment shown in FIG. 9, the elongated body 52 is configured in the shape of an elongated pole, rod, or shaft having a round outer geometry when viewed in cross-section. The hood member 58 is attached to the elongated body 52 at a position near the distal end 56 of the elongated body 52. The one or more electrically conductive contacts 60 capable of delivering a high-voltage shock to an attacker is attached to the distal end 56 of the body 52. The electrically conductive contacts 60 are positioned at a point along the longitudinal length of the elongated body 52 at a point that is distal to the hood member 58. Therefore, the electrically conductive contacts 60 extend from the body 52 from a point that is outwardly from hood 58. The hood 58 has a generally pyramidal configuration, although this shape should be considered to be non-limiting. Proximal end 54 of elongated body 52 comprises handle 62 and an activation member (not shown) for activating the power source for delivering an electrical shock via the electrical conductive contacts 60 to a would-be attacker. It will be appreciated by those skilled in the art that the handle 62 and can take on a variety of shapes and configurations. High-voltage power unit (not shown) is operably associated with elongated body 52 and is selectively actuated by activation member.

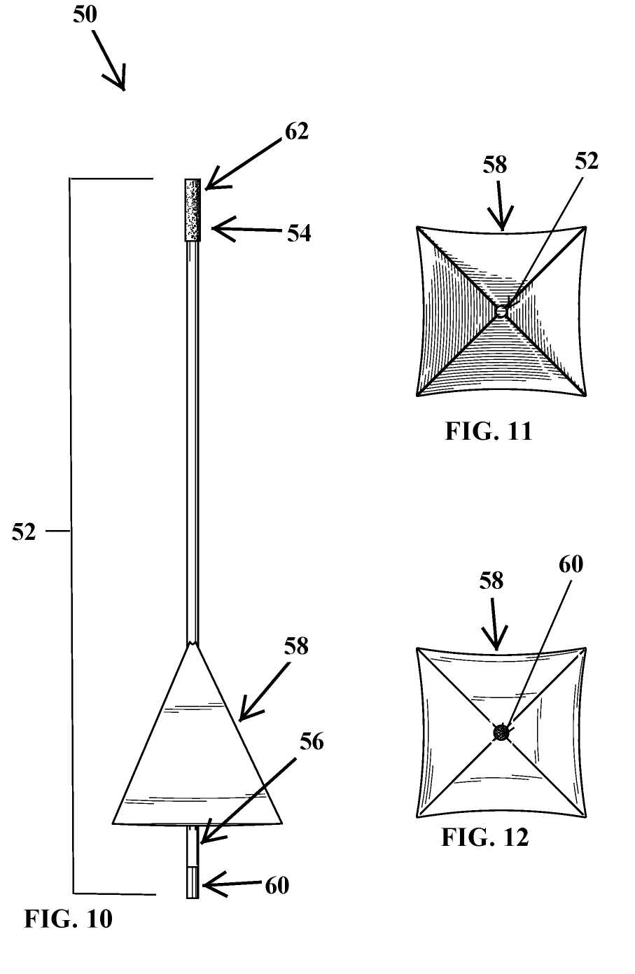

FIG. 10 is a side view of the electrical shock device shown in FIG. 9. Elongated body 52 comprises opposite proximal 54 and distal 56 end portions. The elongated body extends along longitudinal axis extending between proximal 54 and distal 56 ends. The elongated body 52 is configured in the shape of an elongated pole, rod, or shaft having a round outer geometry when viewed in cross-section. The hood member 58 is attached to the elongated body 52 at a position near the distal end 56 of the elongated body 52. The one or more electrically conductive contacts 60 capable of delivering a high-voltage shock to an attacker is attached to the distal end 56 of the body 52. The electrically conductive contacts 60 are positioned at a point along the longitudinal length of the elongated body 52 at a point that is distal to the hood member 58. Therefore, the electrically conductive contacts 60 extend from the body 52 from a point that is outwardly from hood 58. The hood 58 has a generally pyramidal configuration, although this shape should be considered to be non-limiting. Proximal end 54 of elongated body 52 comprises handle 62 and an activation member (not shown) for activating the power source for delivering an electrical shock via the electrical conductive contacts 60 to a would-be attacker. It will be appreciated by those skilled in the art that the handle 62 and can take on a variety of shapes and configurations. High-voltage power unit (not shown) is operably associated with elongated body 52 and is selectively actuated by activation member.

FIG. 11 is a proximal end view of the electrical shock device shown in FIG. 9. The electrically conductive contacts (not shown) are positioned at a point along the longitudinal length of the elongated body 52 at a point that is distal to the hood member 58. Therefore, the electrically conductive contacts extend from the body 52 from a point that is outwardly from hood 58. The hood 58 has a generally octagonal configuration, although this shape should be considered to be non-limiting.

FIG. 12 is a distal end view of the electrical shock device shown in FIG. 9. The electrically conductive contacts 60 are positioned at a point along the longitudinal length of the elongated body at a point that is distal to the hood member 58. Therefore, the electrically conductive contacts 60 extend from the body from a point that is outwardly from hood 58. The hood 58 has a generally octagonal configuration, although this shape should be considered to be non-limiting.

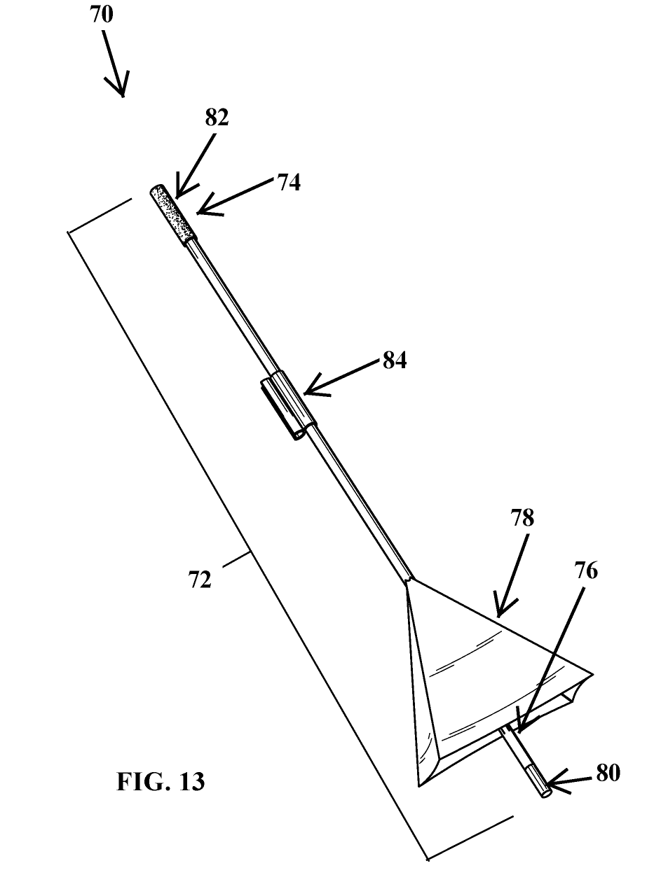

FIG. 13 is a perspective view of a fourth illustrative embodiment of the electrical shock device 70. Electric shock device 70 is generally comprised of an elongated body 72. Elongated body 72 comprises opposite proximal 74 and distal 76 end portions. The elongated body extends along longitudinal axis extending between proximal 74 and distal 76 ends. According to the illustrative embodiment show in FIG. 13, the elongated body 72 is configured in the shape of an elongated pole, rod, or shaft having a round outer geometry when viewed in cross-section. The hood member 78 is attached to the elongated body 72 at a position near the distal end 76 of the elongated body 72. The one or more electrically conductive contacts 80 capable of delivering a high-voltage shock to an attacker is attached to the distal end 76 of the body 72. The electrically conductive contacts 80 are positioned at a point along the longitudinal length of the elongated body 72 at a point that is distal to the hood member 78. Therefore, the electrically conductive contacts 80 extend from the body 72 from a point that is outwardly from hood 78. The hood 78 has a generally pyramidal configuration, although this shape should be considered to be non-limiting. Proximal end 74 of elongated body 72 comprises handle 82 and an activation member (not shown) for activating the power source for delivering an electrical shock via the electrical conductive contacts 80 to a would-be attacker. It will be appreciated by those skilled in the art that the handle 82 and can take on a variety of shapes and configurations. High-voltage power unit (not shown) is operably associated with elongated body 72 and is selectively actuated by activation member. Holding member 84 is positioned along longitudinal axis of said elongated body 72 configured to hold an illumination device, such as a flashlight, to said elongated body.

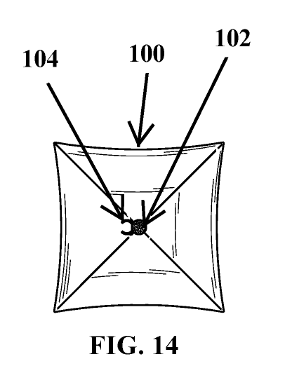

FIG. 14 is a distal end view of a fifth illustrative embodiment of the electrical shock device. The electrically conductive contacts 102 are positioned at a point along the longitudinal length of the elongated body at a point that is distal to the hood member 100. Therefore, the electrically conductive contacts 102 extend from the body from a point that is outwardly from hood 100. The hood 100 has a generally pyramidal configuration, although this shape should be considered to be non-limiting. Holding member 104 is positioned at least partially within the hood 100 along the distal end of said elongated body. Holding member 104 is configured to hold an illumination device (not shown), such as a flashlight, to said elongated body.

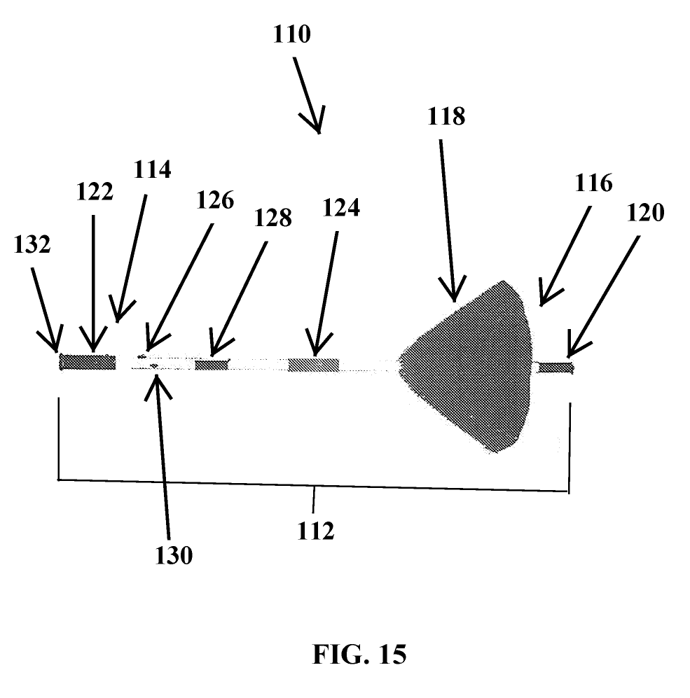

FIG. 15 is a perspective view of a sixth illustrative embodiment of the electrical shock device 110. Electric shock device 110 is generally comprised of an elongated body 112. Elongated body 112 comprises opposite proximal 114 and distal 116 end portions. The elongated body 112 extends along longitudinal axis extending between proximal 114 and distal 116 ends. According to the illustrative embodiment shown in FIG. 15, the elongated body 112 is configured in the shape of an elongated pole, rod, or shaft having a round outer geometry when viewed in cross-section. The hood member 118 is attached to the elongated body 112 at a position near the distal end 116 of the elongated body 112. The one or more electrically conductive contacts 120 capable of delivering a high-voltage shock to an attacker is attached to the distal end 116 of the body 112. The electrically conductive contacts 120 are positioned at a point along the longitudinal length of the elongated body 112 at a point that is distal to the hood member 118. Therefore, the electrically conductive contacts 120 extend from the body 112 from a point that is outwardly from hood 118. Proximal end 114 of elongated body 112 comprises handle 122 and an activation member 126 for activating the power source for delivering an electrical shock via the electrical conductive contacts 120 to a would-be attacker. Proximal end 114 of elongated body 112 also comprises an operating mechanism 130 for opening and closing the hood 118. Proximal end of handle 122 comprises foot pad 132 configured to make contact with the ground surface when electric shock device 110 is being used as a walking stick or cane. Second handle 124 is positioned along a longitudinal axis of said elongated body 112 between said handle 122 and said hood 118. High-voltage power unit (not shown) is operably associated with elongated body 112 and is selectively actuated by activation member 126. Holding member 128 is positioned along longitudinal axis of said elongated body 112 configured to hold an illumination device, such as a flashlight, to said elongated body 112.

While the electric shock device has been described in connection with various embodiments, it is to be understood that other similar embodiments may be used or modifications and additions may be made to the described embodiments for performing the same function. Furthermore, the various illustrative embodiments may be combined to produce the desired results. Therefore, the electric shock device should not be limited to any single embodiment.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. An electric shock device comprising:
an elongated body comprising a longitudinal axis and opposite proximal and distal ends;
a handle at said proximal end of said elongated body;
a hood carried by said elongated body, wherein said hood defines a cavity facing toward said distal end of said elongated body;
an electrically conductive contact at said distal end of said elongated body;
an electric power source in electrical communication with said electrically conductive contact; and
an activation member in communication with said electric power source.

2. The electric shock device of claim 1, wherein said hood is selectively movable between opened and closed positions.

3. The electric shock device of claim 1, wherein said distal end of the elongated body further comprises spring means connected to said hood for opening said hood.

4. The electric shock device of claim 1, wherein said elongated body further comprises a slidable collar member to open and close said hood.

5. The electric shock device of claim 1, wherein said hood, in the opened position, has a substantially cone-shaped configuration.

6. The electric shock device of claim 1, wherein said hood, in the opened position, has a cross-sectional shape selected from the group consisting of a circle, oval, oblong, triangle, a square, a pentagon, a hexagon, a heptagon and an octagon.

7. The electric shock device of claim 1, wherein said electrically conductive contact is positioned outside of said hood.

8. The electric shock device of claim 1, wherein said electrically conductive contact is positioned at least partially within said cavity of said hood.

9. The electric shock device of claim 1, wherein an electrical wiring electrically connects said electrical power source to said electrically conductive contact.

10. The electric shock device of claim 1, wherein said electrical power source comprises a battery and a voltage amplifier.

11. The electric shock device of claim 11, wherein said battery is rechargeable.

12. The electric shock device of claim 1, wherein said electrical power source comprises a power inlet socket, a resistor, a capacitor, a bridge rectifier and a battery.

13. The electric shock device of claim 1, wherein said activation member comprises a power switch and a high-voltage discharge switch, wherein power is supplied to the capacitor by actuating the power switch and the high voltage is supplied to said electrically conductive contact by actuating the discharge switch.

14. The electric shock device of claim 1, wherein a second handle is positioned along a longitudinal axis of said elongated body between said handle and said hood.

15. The electric shock device of claim 1, wherein said elongated body is expandable and retractable in length.

16. The electric shock device of claim 16, wherein said elongated body comprises a second tubular member having an outer diameter less than the inner diameter of a first tubular member, so as to be slidably moved and repositioned with respect thereto.

17. The electric shock device of claim 1, further comprising a foot pad member positioned at said proximal end of said elongated body to assist in walking.

18. The electric shock device of claim 1, wherein a holding member is positioned along longitudinal axis of the elongated body, wherein said holding member is configured to hold an illumination device to said elongated body.

19. The electric shock device of claim 18, wherein said holding member is coaxially engaged about the outer circumference of the elongated body at a position between the proximal end and the hood member.

20. The electric shock device of claim 18, wherein said holding member member is positioned at least partially within said hood along the distal end of said elongated body.
